(19) United States
(12) Patent Application Publication
(10) Pub. No.: US 2006/0075010 A1
(43) Pub. Date: Apr. 6, 2006

(54) Fast fourier transform method and apparatus

(76) Inventors: Kevin R. Wadleigh, Plano, TX (US); David W. Boyd, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/959,725

(22) Filed: Oct. 5, 2004

(51) Int. Cl. G06F 17/14

(52) U.S. Cl. 708/404

(57) ABSTRACT

A method and apparatus, especially suited for computers that can execute fused multiply-add instructions, for performing a fast Fourier transform (FFT) are disclosed. Divisions by zero that create a risk of error in other methods are avoided. In a first example embodiment, a zero divisor is detected and the division circumvented by performing an alternate computation. In a second example embodiment, a zero divisor is detected replaced by a safe finite value. In a third example embodiment, two optimized FFT kernels are used, one avoiding division by a zero real part of a root of unity and one avoiding division by a zero imaginary part. In a fourth example embodiment, a first kernel computes some kernel iterations without multiplication, and a second, optimized kernel computes the remaining iterations without risk of division by zero.

### FIELD OF THE INVENTION

The present invention relates to the computation of the discrete Fourier transform (DFT), and more particularly to the fast Fourier transform (FFT), a class of efficient methods for computing the DFT.

### BACKGROUND OF THE INVENTION

The discrete Fourier transform of the n-long sequence x=(x₀, x₁, x₂, . . . , xₙ₋₁) is defined as

$$F ( f ) = {\sum }_{k = 0}^{n - 1} {x}_{k} {ⅇ}^{- 2 πⅈ fk / n} , 0 \leq f < n$$

The DFT finds broad application in such fields as digital signal processing, communications, and computational mathematics.

As defined, the number of complex operations required to compute a DFT is o(n²) . That is, the number of operations is proportional to the square of the sequence length n. For long sequences, the number of operations and the time required for the DFT computation are prohibitively large.

Because e^{-2πfk/n}=cos(2πfk/n)−i sin(2πfk/n), the DFT may be expressed as

$$F ( f ) = {\sum }_{k = 0}^{n - 1} {x}_{k} ( cos ( 2 π fk / n ) - i sin ( 2 π fk / n ) , 0 \leq f < n$$

As this formulation suggests, the DFT may be thought of as “testing” the sequence x=(x₀, x₁, x₂, . . . , xₙ₋₁) for correlation with a set of sine and cosine functions of various frequencies f in order to reveal periodicity in the sequence. This formulation also suggests that there is considerable redundancy in the computation of the DFT. For example, if n=16, the quantity 2πfk/n takes on only 90 unique values even though the summation is traversed 256 times. Furthermore, many of those 90 values are additionally redundant because of the cyclic nature of the sine and cosine functions, and because the sine and cosine functions are phase-shifted copies of each other. For a sequence of length n, only n unique complex values need be computed to supply the needed sines and cosines (or complex exponentials). These n values are complex roots of unity. They fall on the unit circle in the complex plane and are uniformly spaced around the unit circle.

If n is a composite number (that is, not a prime number), then another, even more powerful approach to exploiting the redundancy in the computation presents itself. For example, suppose n is a multiple of 2. Beginning with the definition of the DFT,

$$F ( f ) = {\sum }_{k = 0}^{n - 1} {x}_{k} {ⅇ}^{- 2 πⅈ fk / n} , 0 \leq f < n$$

the summation can be divided into two smaller summations, one accumulating the even numbered terms and one accumulating the odd.

$$\begin{matrix}F ( f ) = {\sum }_{r = 0}^{n / 2 - 1} {x}_{2 r} {ⅇ}^{- 2 πⅈ f ( 2 r ) / n} + {\sum }_{r = 0}^{n / 2 - 1} {x}_{2 r + 1} {ⅇ}^{- 2 πⅈ f ( 2 r + 1 ) / n} \\ = {\sum }_{r = 0}^{n / 2 - 1} {x}_{2 r} {ⅇ}^{- 2 πⅈ f ( 2 r ) / n} + {ⅇ}^{- 2 πⅈ f / n } {\sum }_{r = 0}^{n / 2 - 1} {x}_{2 r + 1} {ⅇ}^{- 2 πⅈ f ( 2 r ) / n} \\ = {\sum }_{r = 0}^{n / 2 - 1} {x}_{2 r} {ⅇ}^{- 2 πⅈ f r / ( n / 2 )} + {ⅇ}^{- 2 πⅈ f / n } {\sum }_{r = 0}^{n / 2 - 1} {x}_{2 r + 1} {ⅇ}^{- 2 πⅈ f r / ( n / 2 )} \\ = G ( f ) + {ⅇ}^{- 2 πⅈ f / n} H ( f )\end{matrix}$$

It will be noted that G(f) and H(f) are both n/2-point DFT's. G(f) is an n/2-point DFT of the even-numbered elements of sequence x, and H(f) is an n/2-point DFT of the odd-numbered elements of sequence x. At first glance, this does not appear to be an improvement, if both sums are evaluated for 0≦f<n. However, it is not necessary to evaluate each sum for n values of f. Both G(f) and H(f) are cyclic with period n/2. That is G(n/2)=G(0), G(n/2+1)=G(1), and so forth. Therefore it is only necessary to evaluate n/2 values of each G(f) and H(f), so that each requires only one fourth as much computation as the DFT as originally formulated. Thus, the total amount of necessary computation has been cut nearly in half. (The computation necessary to evaluate G(f) and H(f) is half of that required to compute F(f) in the original formulation, but the elements of H(f) must be multiplied by e^{-2πif/n} and added to the elements of G(f), adding some computational overhead.)

FIG. 1 shows an 8-point DFT after decomposition by the above technique, in signal flow graph form. For compactness of notation, e^{-2πif/n} is denoted in the signal flow graph as Wₙ^{f}. Each node in the signal flow graph holds a value that is the sum of the signals entering the node along directed paths. A value next to a directed path multiplies the value being carried. For example, node F(0) holds the value of node G(0) (carried directly from node G(0)) plus Wₙ⁰ times the value of node H(0).

Note that F(4) is also a function of the values of G(0) and H(0). The interactions of nodes G(0), H(0), F(0), and F(4) have been extracted from FIG. 1 and shown in FIG. 2. The butterfly-shaped diagram of FIG. 2 may be recognized as a two-point DFT. Similarly, nodes G(1), H(1), F(2), and F(5) interact in butterfly fashion, and the pattern is repeated two more times in FIG. 1. Thus, the original n-point DFT has been reduced to two n/2-point DFTs performed in a first “stage”, and n/2 2-point DFTs performed in a second “stage”.

If n/2 is also even (as is true in FIG. 1), then the above process may be repeated, reducing the two n/2-point DFTs of the first stage to four n/4-point DFTs, nearly halving again the computational effort require to evaluate them. For n=8, the original 8-point DFT is then reduced to three stages, each stage containing four 2-point DFTs. Because the computational complexity of each DFT is o(n²), computing 12 2-point DFTs is more efficient than computing a single 8-point DFT. The relative complexity of computing 12 2-point DFTs is 12×2²=48, while the relative complexity of computing an 8-point DFT directly is 8²=64.

Similarly, a 16-point DFT may be reduced to four stages each containing eight 2-point DFTs, a 32-point DFT may be reduced to five stages each containing 16 2-point DFTs, and so forth.

This technique of dividing a DFT into a series of smaller DFTs is the basis of the fast Fourier transform (FFT). What has been described thus far is called a “radix-2” FFT, because each of its most basic units is a 2-point DFT. It can be easily shown that the relative computational complexity of radix-2 FFT is o(n log₂ n). That is, the number of operations required to perform the FFT is proportional to n log₂ n . For large values of n, this represents a truly enormous gain in efficiency compared with the o(n²) complexity of the original DFT formulation, and the FFT has made practicable many applications of the DFT that were previously computationally intractable. A traditional FFT implementation, also called the standard Stockham formulation, for a sequence of length n=2^{m} is given in Listing 1 below. (See David H. Bailey, “A High-Performance FFT Algorithm for Vector Supercomputers”, Intl. Journal of Supercomputer Applications, vol. 2, no. 1, pg 82-87, 1988.)

Listing 1. Traditional Radix-2 FFT

```
FOR j = 0 to n−1
    F₀(j) = x(j)
NEXT j
FOR t = 1 to m
    FOR k = 0 to 2^{t-1} − 1
        α = e^{-2πik/2}^{t}
        FOR j = 0 to 2^{m-t} − 1
            Fₜ(j2^{t} + k) = Fₜ₋₁(j2^{t-1} + k) + αFₜ₋₁(j2^{t-1} + n/2 + k)
            Fₜ(j2^{t} + 2^{t-1} + k) = Fₜ₋₁(j2^{t-1} + k) − αFₜ₋₁(j2^{t-1} + n/2 + k)
        NEXT j
    NEXT k
NEXT t
```

Several features of Listing 1 are notable. The variable t counts the stages of the FFT. The innermost loop, indexed by variable j, is executed once for each of the basic DFT units in each phase. Other than the index and counting variables j, k, m, n, and t, all of the quantities are complex, having real and imaginary parts. (Commonly, but not necessarily, the input sequence x is a sequence of real numbers.) The real and imaginary parts are typically stored as floating-point values. Adding two complex values uses two floating-point additions. Multiplying two complex values uses four floating-point multiplications, one floating-point addition and one floating point subtraction. In general, subtractions are counted as additions since they are computationally similar.

The statements inside the innermost loop in Listing 1 perform the most basic DFT unit of the FFT, and are called the FFT “kernel”. The kernel of the radix-2 FFT of Listing 1 operates on two complex values from array F, using one root of unity (α), and stores two complex values that will be found in array F during the next stage of the FFT.

Many computer implementations of the FFT are radix-2 FFTs. However, a complete radix-2 FFT requires that the sequence x have a length n that is a power of two, that is n=2^{l}. For the purposes of this disclosure, a complete radix-R FFT is one where n is a power of R, and only radix-R kernels are used.

FFTs may be derived in other radices, which may be useful for certain applications. For example, if n is a multiple of 3, the summation in the definition of the DFT can be divided into three smaller summations, each accumulating one third of the terms in the summation. By a technique similar to that given in the derivation of the radix-2 FFT given above, an n-point DFT may be divided into three n/3-point DFTs performed in a first stage, and n/3 3-point DFTs performed in a second stage. If n is a power of 3, that is n=3^{l}, then the process may be repeated l−1 times, resulting in l stages, each containing n/3 3-point DFTs. This would be a complete radix-3 FFT.

“Mixed-radix” FFTs are also possible, wherein not all of the stages of an FFT use the same radix. For example, a 20-point DFT may be computed in two stages, the first stage containing four 5-point DFTs, and the second stage containing five 4-point DFTs, or vice versa. The relative computational complexity of such a split would be 4×5²+5×4² =180, compared with a relative complexity of 20²=400 for a 20-point DFT computed according to the DFT definition. Mixed-radix FFTs are especially useful for transforming data sets of lengths that differ significantly from any power of two.

When a data set is of a length that permits a choice between two radices, it is often advantageous to use the higher radix. A first reason for using the higher radix is that a higher radix kernel may often be more computationally efficient than the lower-radix kernels it replaces. For example, a 1024-point DFT may be computed using a radix-2 FFT or a radix-4 FFT. The simple complexity estimate used so far indicates no advantage for the radix-4 FFT (10×512×2²=5×256×4²=20480). However each radix-4 kernel can be coded more efficiently than the four radix-2 kernels it replaces, so the radix-4 FFT is about 15 percent more efficient than the radix-2 FFT.

A second reason for preferring a higher radix is that a higher radix enables the FFT to be computed with less data traffic between a computer's central processing unit (CPU) and memory. In modem computers, memory access time is often a significant limitation on program performance. A traditional radix-4 FFT implementation for a sequence of length n=4^{m} is given in Listing 2 below. (See David H. Bailey, “A High-Performance Fast Fourier Transform Algorithm for the Cray-2”, Journal of Supercomputing, vol. 1, no. 1, pg 43-60, July, 1987.)

Listing 2. Traditional Radix-4 FFT

```
FOR j = 0 to n−1
        F₀(j) = x(j)
    NEXT j
    FOR t = 1 to m
        FOR k = 0 to 4^{t-1} − 1
            β₁ = e^{-2πik/4}^{t}
            β₂ = β₁²
            β₃ = β₁³
            FOR j = 0 to 4^{m-t} − 1
                c₀ = Fₜ₋₁(j4^{t-1} + k)
                c₁ = β₁Fₜ₋₁(j4^{t-1} + n/4 + k)
                c₂ = β₂Fₜ₋₁(j4^{t-1} + 2n/4 + k)
                c₃ = β₃Fₜ₋₁(j4^{t-1} + 3n/4 + k)
                d₀ = c₀ + c₂
                d₁ = c₀ − c₂
                d₂ = c₁ + c₃
                d₃ = −i(c₁ − c₃)
                Fₜ(j4^{t} + k) = d₀ + d₂
                Fₜ(j4^{t} + 4^{t-1} + k) = d₁ + d₃
                Fₜ(j4^{t} + 2 · 4^{t-1} + k) = d₀ − d₂
                Fₜ(j4^{t} + 3 · 4^{t-1} + k) = d₁ − d₃
            NEXT j
        NEXT k
    NEXT t
```

In striving for maximum FFT performance (minimum execution time on a computer), programmers often attempt to exploit the unique capabilities of a particular computer, for example by optimizing code to use instruction forms unique to the computer. One such optimization has been described by Goedecker. To understand the optimization, and a potential problem with its use, it is useful to examine how the pseudo code of Listing 2 translates to lower-level programming instructions.

Listing 3 is a listing of lower-level operations that implement the kernel of the traditional FFT implementation of Listing 1. In Listing 3, the four complex values being operated on by the kernel are designated for compactness of notation as Fᵢₙ(0) . . . Fᵢₙ(3), and the four complex values computed by the kernel are designated Fₒᵤₜ(0) . . . Fₒᵤₜ(3). (In general, these will not be elements 0-3 of arrays Fₜ₋₁ or Fₜ. For example, Fᵢₙ(0) is actually Fₜ₋₁(j4^{t-1}+k), etc.) A real or imaginary part of any complex value can be held in one machine register, and is designated by the subscript ᵣₑₐₗ or _{imag}. For example, the real part of the first complex input value is Fₜ₋₁(0)ᵣₑₐₗ. All quantities in Listing 3 are floating-point values, and are generally stored each in a single machine register. The quantities β₁, β₂, and β₃ have been computed outside the kernel.

Listing 3. Traditional Radix-4 Kernel

r1 = Fᵢₙ(0)ᵣₑₐₗ
s1 = Fᵢₙ(0)_{imag}
r = Fᵢₙ(1)ᵣₑₐₗ
s = Fᵢₙ(1)_{imag}
r2 = r*β₁ᵣₑₐₗ − s*β_{1imag}
s2 = r*β_{1imag} + s*β₁ᵣₑₐₗ
r = Fᵢₙ(2)ᵣₑₐₗ
s = Fᵢₙ(2)_{imag}
r3 = r*β₂ᵣₑₐₗ − s*β_{2imag}
s3 = r*β_{2imag} + s*β₂ᵣₑₐₗ
r = Fᵢₙ(3)ᵣₑₐₗ
s = Fᵢₙ(3)_{imag}
r4 = r*β₃ᵣₑₐₗ − s*β_{3imag}
s4 = r*β_{3imag} + s*β₃ᵣₑₐₗ
r = r1 + r3
s = r2 + r4
Fₒᵤₜ(0)ᵣₑₐₗ = r + s
Fₒᵤₜ(2)ᵣₑₐₗ = r − s
r = r1 − r3
s = s4 − s2
Fₒᵤₜ(1)ᵣₑₐₗ = r − s
Fₒᵤₜ(3)ᵣₑₐₗ = r + s
r = s1 + s3
s = s2 + s4
Fₒᵤₜ(0)_{imag} = r + s
Fₒᵤₜ(2)_{imag} = r − s
r = s1 − s3
s = r4 − r2
Fₒᵤₜ(1)_{imag} = r + s
Fₒᵤₜ(3)_{imag} = r − s

As is apparent from Listing 3, the radix-4 kernel can be computed using 12 floating-point multiplies and 22 floating-point additions, or 34 total floating-point computation instructions. (Subtractions are counted as additions, because they are operationally similar.) Eight data loading instructions and eight data storing instructions are also used, so that the kernel uses a total of 50 instructions. While this implementation is quite efficient on many computers, it does not take full advantage of the capabilities of a computer having a CPU that can execute “fused multiply-add” instructions.

Many computer CPUs support traditional floating-point multiply instructions of the form
C=A*B
as well as addition and subtraction.

In order to implement the kernel of Listing 3 on a computer that supports only traditional instructions, the operation
r2=r*β₁ᵣₑₐₗ−s*β_{1imag}
requires three instructions. Each multiplication is performed in a separate instruction, and then the products are added together in a third instruction.

A fused multiply-add (FMA) instruction is of the form
D=±A*B±C

In an FMA instruction, a multiplication and an addition are performed in a single instruction. Many computers can execute an FMA instruction in less time than the two operations would take on a computer without FMA capability. A computer with FMA capability could execute the operation
r2=r*β₁ᵣₑₐₗ−s*β_{1imag}
using only two instructions. The first multiplication could be performed traditionally, and then the second multiplication and the addition (subtraction, in this case) could be performed with an FMA instruction. This is an improvement, but still doesn't take full advantage of an FMA-enabled CPU.

A further improvement may be had by applying the coding optimization described by Goedecker. (See S. Goedecker, Fast Radix 2, 3, 4, and 5 Kernels for Fast Fourier Transformations on Computers with Overlapping Multiply-add Instructions, SIAM J Sci. Comput., Vol. 18, 1605-1611, 1997.) In Goedecker's optimization, the values of β₁, β₂, and β₃ are adjusted before the kernel computation in a way that enables the kernel computations to be performed using only FMA instructions. Listing 4 is a listing of operations that implement the kernel of Listing 2, but with Goedecker's optimization applied.

Listing 4. Radix-4 Kernal with Goedecker's Optimization

β_{1imag} = β_{1imag} / β₁ᵣₑₐₗ
β_{2imag} = β_{2imag} / β₂ᵣₑₐₗ
β_{3imag} = β_{3imag} / β₃ᵣₑₐₗ
β₃₁ᵣₑₐₗ = β₃ᵣₑₐₗ / β₁ᵣₑₐₗ
r1 = Fᵢₙ(0)ᵣₑₐₗ
s1 = Fᵢₙ(0)_{imag}
r = Fᵢₙ(1)ᵣₑₐₗ
s = Fᵢₙ(1)_{imag}
r2 = r − s*β_{1imag}
s2 = r*β_{1imag} + s
r = Fᵢₙ(2)ᵣₑₐₗ
s = Fᵢₙ(2)_{imag}
r3 = r − s*β_{2imag}
s3 = r*β_{2imag} + s
r = Fᵢₙ(3)ᵣₑₐₗ
s = Fᵢₙ(3)_{imag}
r4 = r − s*β_{3imag}
s4 = r*β_{3imag} + s
r = r1 + r3*β₂ᵣₑₐₗ
s = r2 + r4*β₃₁ᵣₑₐₗ
Fₒᵤₜ(0)ᵣₑₐₗ = r + s*β₁ᵣₑₐₗ
Fₒᵤₜ(2)ᵣₑₐₗ = r − s*β₁ᵣₑₐₗ
r = r1 − r3*β₂ᵣₑₐₗ
s = s4*β₃₁ᵣₑₐₗ − s2
Fₒᵤₜ(1)ᵣₑₐₗ = r − s*β₁ᵣₑₐₗ
Fₒᵤₜ(3)ᵣₑₐₗ = r + s*β₁ᵣₑₐₗ
r = s1 + s3*β₂ᵣₑₐₗ
s = s2 + s4*β₃₁ᵣₑₐₗ
Fₒᵤₜ(0)_{imag} = r + s*β₁ᵣₑₐₗ
Fₒᵤₜ(2)_{imag} = r − s*β₁ᵣₑₐₗ
r = s1 − s3*β₂ᵣₑₐₗ
s = r4* β₃₁ᵣₑₐₗ − r2
Fₒᵤₜ(1)_{imag} = r + s*β₁ᵣₑₐₗ
Fₒᵤₜ(3)_{imag} = r − s*β₁ᵣₑₐₗ

In Listing 4, four floating-point divisions have been added, but these adjustments to the roots of unity may be pre-computed outside the kernel. All of the other 22 computational steps have been converted to a form implementable with a single FMA instruction per step. While the optimized implementation uses 22 floating-point multiplies and 22 floating-point additions, on a computer with FMA capability, each additional multiply (compared with the implementation of Listing 3) is performed in the same instruction as an addition, using multiplication capabilities that would otherwise have been idle. The number of floating-point instructions has been reduced from 34 to 22, and the total number of instructions in the kernel has been reduced from 50 to 38 (the eight data loading and eight data storing instructions are still used). For many, if not all, of the FFT stages, the accumulated time saving due to the more efficient kernel outweighs the additional time required to perform the division, so the speed of a program utilizing Goedecker's optimization is improved as compared with a program without the optimization.

However, there is a potential difficulty with Goedecker's optimization for some sequence lengths n. The divisions introduced by the optimization divide the imaginary part of each root of unity used in the kernel by the real part of the corresponding root. In some cases, the real part may be zero, causing a “divide-by-zero” error. For example, if n is a multiple of 4 and a radix-4 kernel is used, in some kernel iterations β₁=e^{-πi/4}=\sqrt{2}/2 −i\sqrt{2}/2 and β₂=β₁²=0−1i. When the imaginary part of β₂ is divided by the real part, a divide-by-zero error can occur. The computer may substitute a value of infinity for the result, and then use this value in subsequent calculations, introducing errors. β₁\sqrt{2}/2−i\sqrt{2}/2 may be considered an “unsafe” value.

Mixed-radix FFT implementations enable the existence of more unsafe values than do single-radix FFTs. For example, if n is a multiple of both 3 and 4, then both radix-3 and radix-4 kernels may be used in a mixed-radix FFT computation. One of the roots of unity involved in such an FFT computation is β₁=e^{-πi/6} so that in some iterations of the radix-4 kernel, β₃β₁³=e^{-πi/2}=0−1i.

Thus the problem of unsafe values for the roots of unity is especially troublesome for mixed-radix FFTs. Mixed-radix FFTs, in turn, are especially useful for taking advantage of the performance benefits of large-radix kernels. Consider for example computing the DFT of a sequence x of length n=144,000. If only a radix-2 FFT program is available, the sequence must be padded, for example with zeros, so that its length is the next higher power of two beyond 144,000, or 262,144. The radix-2 FFT would then perform much wasted calculation, computing a DFT of nearly twice the length actually desired.

However, if a computer program is available that is based on a 2-, 3-, 5-mixed-radix FFT implementation that can perform FFT stages with radix-9 and radix-16 kernels, then no padding is necessary at all (because 144,000 is a multiple of powers of 2, 3, and 5). No wasted calculation is performed, and both kernels are large, enabling further performance gains due to the reduced memory traffic enabled by large kernels.

A method is needed to enable maximum FFT performance and accuracy on a computer with fused multiply-add capability.

### SUMMARY OF THE INVENTION

In a method and apparatus for performing a fast Fourier transform (FFT), occasions for division by zero are avoided. In a first example embodiment, a zero divisor is detected and the division circumvented by performing an alternate computation. In a second example embodiment, a zero divisor is detected and replaced by a safe finite value. In a third example embodiment, two FFT kernels are used, one avoiding division by a zero real part of a root of unity and one avoiding division by a zero imaginary part. In a fourth example embodiment, a first kernel computes some kernel iterations without multiplication, and a second kernel, using fused multiply-add computer instructions, computes the remaining iterations without risk of division by zero.

### BRIEF DESCRIPTION OF THE DRAWINGS

FIG. 1 illustrates, in signal flow graph form, the decomposition of an 8-point DFT into two stages, the first stage comprising two 4-point DFTs.

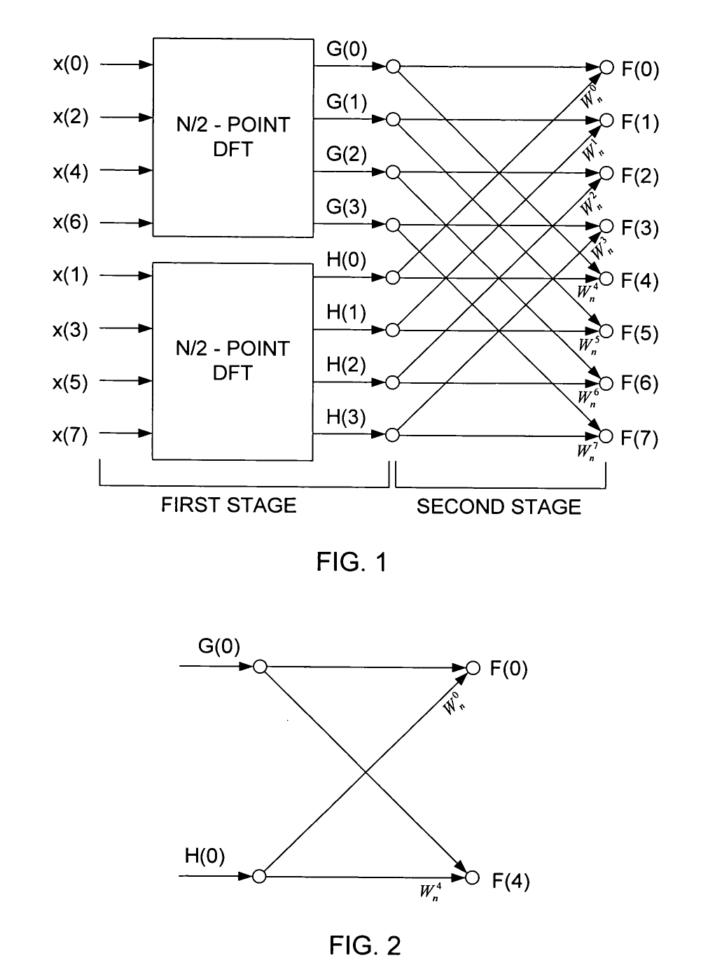

FIG. 2 illustrates a “butterfly” computation that occurs in the second stage of the DFT of FIG. 1.

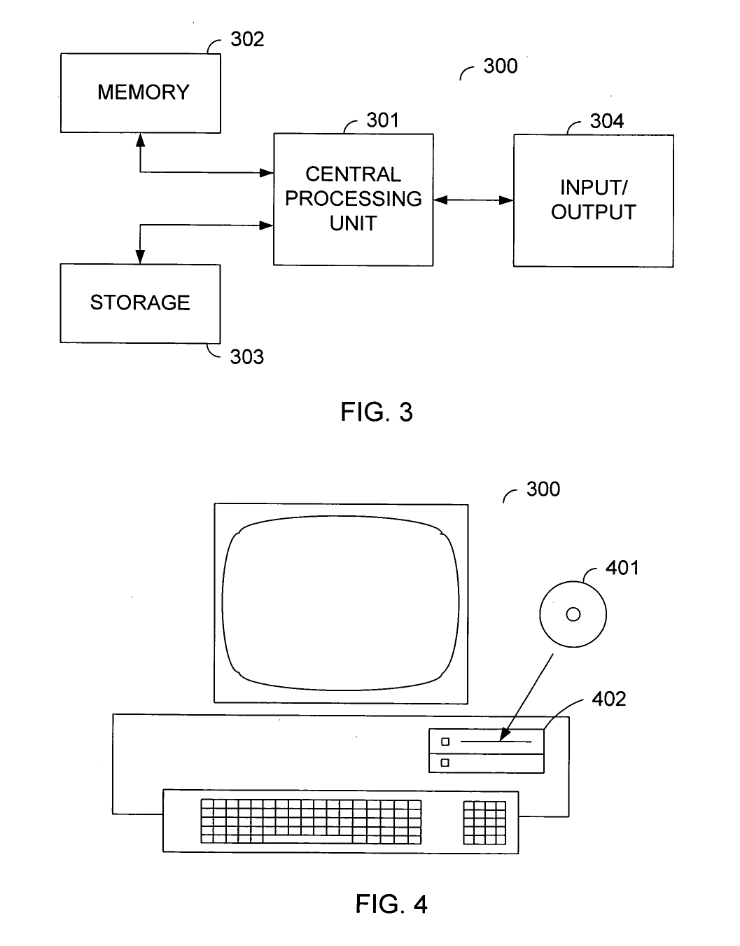

### DETAILED DESCRIPTION

In a method in accordance with a first example embodiment of the invention, roots of unity that may have zero real parts are tested. If a root is found with a zero real part that would cause a division by zero in an FFT kernel incorporating Goedecker's optimization, a traditional kernel is executed instead of an optimized kernel for the FFT iteration that includes that root. Because relatively few kernel executions include roots of unity with zero real parts, the performance penalty resulting from the occasional execution of a slower traditional kernel is relatively small. For example, in computing a DFT of a sequence of length n=16,384 using the complete radix-4 FFT implementation of Listing 2, the kernel is executed 28,672 times (7 stages×16,384/4 4-point DFTs per stage), but only 1,365 of those kernel executions include a root of unity with a zero real part.

Furthermore, the increased computational overhead of testing the roots of unity for zero real parts is small because not all of the roots must be tested. In a complete radix-4 FFT implementation, only β₂ can ever have a zero real part, so only β₂ need be tested. Mixed-radix implementations may require testing of more than one root of unity for a zero real part. For example, if n is a multiple of both 3 and 4 and a radix-4 kernel is used for some stages, both β₂ and β₃ would be tested.

Listing 5 is a pseudo code implementation of a complete radix-4 FFT in accordance with this first example embodiment of the invention.

Listing 5. Radix-4 FFT in According with a First Example Embodiment

```
FOR j = 0 to n−1
    F (j) = x(j)
NEXT j
FOR t = 1 to m
    FOR k = 0 to 4^{t-1} − 1
        β₁ = e^{-2πik}/4^{t}
        β₂ = β₁²
        β₃ = β₁³
        IF β₂ᵣₑₐₗ = 0.0 THEN
            FOR j = 0 to 4^{m-t} − 1
                Execute traditional kernel of Listing 3, storing results
                in Fₜₑₘₚ
            NEXT j
        ELSE
            β_{1imag} = β_{1imag} / β₁ᵣₑₐₗ
            β_{2imag} = β_{2imag} / β₂ᵣₑₐₗ
            β_{3imag} = β_{3imag} / β₃ᵣₑₐₗ
            β₃₁ᵣₑₐₗ = β₃ᵣₑₐₗ / β₁ᵣₑₐₗ
            FOR j = 0 to 4^{m-t} − 1
                Execute optimized kernel of Listing 4, storing results
                in Fₜₑₘₚ
            NEXT j
        END IF
    NEXT k
    FOR j = 0 to n−1
        F (j) = Fₜₑₘₚ(j)
    NEXT j
NEXT t
```

This first example embodiment may be implemented in FFTs using other kernel sizes as well. For example, a traditional kernel for a complete radix-2 FFT is given in Listing 6 below.

Listing 6. Traditional Radix-2 Kernel

r1 = Fᵢₙ(0)ᵣₑₐₗ
s1 = Fᵢₙ(0)_{imag}
r = Fᵢₙ(1)ᵣₑₐₗ
s = Fᵢₙ(1)_{imag}
r2 = r*αᵣₑₐₗ − s*α_{imag}
s2 = r*α_{imag} + s*αᵣₑₐₗ
Fₒᵤₜ(0)ᵣₑₐₗ = r2 + r1
Fₒᵤₜ(0)_{imag} = s2 + s1
Fₒᵤₜ(1)ᵣₑₐₗ = r1 − r2
Fₒᵤₜ(1)_{imag} = s1 − s2

This traditional radix-2 kernel uses four floating-point multiplications and six floating point additions, for a total of 10 floating-point computation instructions. A Goedecker-optimized radix-2 kernel is shown in Listing 7 below.

Listing 7. Radix-2 Kernal with Gloedecker's Optimization

α_{imag} = α_{imag}/αᵣₑₐₗ
r1 = Fᵢₙ (0)ᵣₑₐₗ
s1 = Fᵢₙ (0)_{imag}
r = Fᵢₙ (1)ᵣₑₐₗ
s = Fᵢₙ (1)_{imag}
r2 = r − s*α_{imag}
s2 = r*α_{imag} + S
Fₒᵤₜ (0)ᵣₑₐₗ = r2*αᵣₑₐₗ + r1
Fₒᵤₜ (0)_{imag} = s2*αᵣₑₐₗ + s1
Fₒᵤₜ (1)ᵣₑₐₗ = r1 − r2*αᵣₑₐₗ
Fₒᵤₜ (1)_{imag} = s1 − s2*αᵣₑₐₗ

This radix-2 kernel using Goedecker's optimization uses six floating-point multiplies and six floating-point additions, but because the additions and multiplications can be implemented in a fused instruction, the kernel uses only six floating-point computation instructions on a computer with FMA capability. Listing 8 is a pseudo code implementation of a complete radix-2 FFT in accordance with this first example embodiment of the invention.

Listing 8. Radix-2 FFT in Accordance with a First Example Embodiment

```
FOR j = 0 to n−1
    F (j) = x(j)
NEXT j
FOR t = 1 to m
    FOR k = 0 to 2^{t-1} − 1
        α = e^{-2πik/4}^{t}
        IF αᵣₑₐₗ = 0.0 THEN
            FOR j = 0 to 2^{m-t} − 1
                Execute traditional kernel of Listing 6, storing results
                in Fₜₑₘₚ
            NEXT j
        ELSE
            α_{imag} = α_{imag} / αᵣₑₐₗ
            FOR j = 0 to 2^{m-t} − 1
                Execute optimized kernel of Listing 7, storing results
                in Fₜₑₘₚ
            NEXT j
        END IF
    NEXT k
    FOR j = 0 to n−1
        F (j) = Fₜₑₘₚ(j)
    NEXT j
NEXT t
```

In a method in accordance with a second example embodiment of the invention, roots of unity that may cause division by zero are tested. If an imminent division by zero is detected, the part of the root that is zero is replaced by a safe finite value. A safe finite value is one that can be divided into one without causing a computational overflow, but is sufficiently close to zero that any subsequent error introduced into the FFT computation is negligible.

The range of values that are safe depends on the processor that is in use and the number storage format being used in the computation. For computers that store floating-point values in IEEE (Institute of Electrical and Electronics Engineers) standard formats, the minimum values, sfmin, that can be divided into one without causing computational overflow are given in Table 1 below. In the art, a small safe finite value is sometimes referred to as a “safe minimum”.

TABLE 1
Minimum Safe Finite Values for IEEE Formats

| Number | | sfmin IEEE |
|---|---|---|
| Storage | sfmin Decimal | Hexadecimal |
| Format | Representation | Representation |
| 32-bit | 0.11754943508222875E−37 | 00800000 |
| 64-bit | 0.22250738585072014E−307 | 0010000000000000 |

Because both the real and imaginary parts of all of the roots of unity will always have a magnitude of one or smaller, a value that can safely be divided into one can also safely be divided into either part of any root of unity involved in the FFT calculation. Note that the values in Table 1 are the minimum values that can serve as safe finite values for those particular number storage formats; other values may be used as well. For example, normal rounding in the computation of the roots of unity on a computer that uses 64-bit arithmetic may often result in rounding errors of approximately 10E-17. This suggests that values as large as 1.0E-20 may serve as safe finite values. In order to avoid introducing error into the computation, a smaller value is generally preferred.

Listing 9 is a pseudo code implementation of a complete radix-4 FFT in accordance with this second example embodiment of the invention.

Listing 9. Radix-4 FFT in Accordance with a Second Example
Embodiment

```
FOR j = 0 to n−1
    F (j) = x(j)
NEXT j
FOR t = 1 to m
    FOR k = 0 to 4^{t-1} − 1
        β₁ = e^{-2πik/4}^{t}
        β₂ = β₁²
        β₃ = β₁³
        IF β₂ᵣₑₐₗ = 0.0 THEN β₂ᵣₑₐₗ = safe_finite_value
        β_{1imag} = β_{1imag} / β₁ᵣₑₐₗ
        β_{2imag} = β_{2imag} / β₂ᵣₑₐₗ
        β_{3imag} = β_{3imag} / β₃ᵣₑₐₗ
        β₃₁ᵣₑₐₗ = β₃ᵣₑₐₗ / β₁ᵣₑₐₗ
        FOR j = 0 to 4^{m-t} − 1
            Execute optimized kernel of Listing 4, storing results in
            Fₜₑₘₚ
        NEXT j
    NEXT k
    FOR j = 0 to n−1
        F (j) = Fₜₑₘₚ(j)
    NEXT j
NEXT t
```

Listing 10 is a pseudo code implementation of a complete radix-2 FFT in accordance with this second example embodiment of the invention.

Listing 10. Radix-2 FFT in Accordance with a Second Example
Embodiment

```
FOR j = 0 to n−1
    F (j) = x(j)
NEXT j
FOR t = 1 to m
    FOR k = 0 to 2^{t-1} − 1
        α = e^{-2πik/2}^{t}
        IF αᵣₑₐₗ = 0.0 THEN αᵣₑₐₗ = safe_finite_value
        α_{imag} = α_{imag} / αᵣₑₐₗ
        FOR j = 0 to 2^{m-t} − 1
            Execute optimized kernel of Listing 7, storing results in
            Fₜₑₘₚ
        NEXT j
    NEXT k
    FOR j = 0 to n−1
        F (j) = Fₜₑₘₚ(j)
    NEXT j
NEXT t
```

In a method in accordance with a third example embodiment of the invention, a kernel optimization is used that begins with dividing the real parts of the roots of unity by the imaginary parts, and then organizing the kernel computation so that all of the floating-point computational instructions used are FMA instructions. This new optimization may be thought of as the reverse of Goedecker's optimization. In Goedecker's optimization, the imaginary parts of the roots of unity are divided by the real parts; in the new optimization, the real parts are divided by the imaginary parts. In a radix-4 FFT, each root of unity is a power of e^{-2πik/4}^{^{t}}. Because e^{-2πik/4}^{^{t}}=cos(2πk/4^{t})−i sin(2πk/4^{t}), a traditional kernel may be thought of as using as the real and imaginary parts of its roots of unity the cosines and sines of the angle 2πk/4^{t} and multiples thereof. These angles are sometimes called the “twiddling angles.” A Goedecker-optimized kernel uses the cosines and tangents of the twiddling angles. A kernel using the new optimizations uses the sines and cotangents of the twiddling angles. Listing 11 is a listing of operations that implement the kernel of Listing 2, but with this new optimization applied.

Listing 11. Radix-4 Kernel with New Optimization

β₁ᵣₑₐₗ = β₁ᵣₑₐₗ / β_{1imag}
β₂ᵣₑₐₗ = β₂ᵣₑₐₗ / β_{2imag}
β₃ᵣₑₐₗ = β₃ᵣₑₐₗ / β_{3imag}
β_{31imag} = β_{3imag} / β_{1imag}
r1 = Fᵢₙ(0)ᵣₑₐₗ
s1 = Fᵢₙ(0)_{imag}
r = Fᵢₙ(1)ᵣₑₐₗ
s = Fᵢₙ(1)_{imag}
r2 = r*β₁ᵣₑₐₗ − s
s2 = r + s*β₁ᵣₑₐₗ
r = Fᵢₙ(2)ᵣₑₐₗ
s = Fᵢₙ(2)_{imag}
r3 = r*β₂ᵣₑₐₗ − s
s3 = r + s*β₂ᵣₑₐₗ
r = Fᵢₙ(3)ᵣₑₐₗ
s = Fᵢₙ(3)_{imag}
r4 = r * β₃ᵣₑₐₗ − s
s4 = r + s*β₃ᵣₑₐₗ
r = r1 + r3*β_{2imag}
s = r2 + r4*β_{31imag}
Fₒᵤₜ(0)ᵣₑₐₗ = r + s*β_{1imag}
Fₒᵤₜ(2)ᵣₑₐₗ = r − s*β_{1imag}
r = r1 − r3*β_{2imag}
s = s4*β_{31imag} − s2
Fₒᵤₜ(1)ᵣₑₐₗ = r − s*β_{1imag}
Fₒᵤₜ(3)ᵣₑₐₗ = r + s*β_{1imag}
r = s1 + s3*β_{2imag}
s = s2 + s4*β_{31imag}
Fₒᵤₜ(0)_{imag} = r + s*β_{1imag}
Fₒᵤₜ(2)_{imag} = r − s*β_{1imag}
r = s1 − s3*β_{2imag}
s = r4*β_{31imag} − r2
Fₒᵤₜ(1)_{imag} = r + s*β_{1imag}
Fₒᵤₜ(3)_{imag} = r − s*β_{1imag}

Similar to the Goedecker-optimized kernel of Listing 4, this kernel uses the modified roots of unity in such a way that the kernel computation can be done with 38 total instructions, 22 FMA instructions, eight data loading instructions, and eight data storing instructions. The kernel of Listing 11 may be used in a manner similar to the way the Goedecker-optimized kernel of Listing 4 is used in the first example embodiment. That is, the imaginary parts of any roots of unity that might result in divisions by zero can be tested, and an alternate traditional kernel executed if a root with a zero imaginary part is found. The method of the second example embodiment may be used with the kernel of Listing 11 as well. That is, any imaginary part of a root of unity that is zero may be replaced by a safe finite value.

Alternatively, for at least some radices, both optimized kernels can be used in concert. When a root of unity is recognized to have a zero real part, the kernel of Listing 11 may be used, and when a root of unity is recognized to have a zero imaginary part, the kernel of Listing 4 may be used. No root can have both real and imaginary parts zero, and for at least some radices, no set of β₁ and its powers will include a root with a zero real part and a root with a zero imaginary part. Therefore, for at least some radices, at least one of the two kernels is safe for each kernel iteration. If neither part of any tested roots is zero, then either kernel may be used. Listing 12 is a pseudo code implementation of a complete radix-4 FFT in accordance with this third example embodiment of the invention. Note that if β₂ᵣₑₐₗ=0.0, it is unnecessary to divide β₂ᵣₑₐₗ by β_{2imag}.

Listing 12. Radix-4 FFT in Accordance with a Third Example
Embodiment

```
FOR j = 0 to n−1
  F (j) = x(j)
NEXT j
FOR t = 1 to m
  FOR k = 0 to 4^{t-1} − 1
    β₁ = e^{-2πik/4}^{t}
    β₂ = β₁²
    β₃ = β₁³
    IF β₂ᵣₑₐₗ = 0.0 THEN
      β₁ᵣₑₐₗ = β₁ᵣₑₐₗ / β_{1imag}
      β₃ᵣₑₐₗ = β₃ᵣₑₐₗ / β_{3imag}
      β_{31imag} = β_{3imag} / β_{1imag}
      FOR j = 0 to 4^{m-t} − 1
        Execute optimized kernel of Listing 11, storing results in Fₜₑₘₚ
      NEXT j
    ELSE
      β_{1imag} = β_{1imag} / β₁ᵣₑₐₗ
      β_{2imag} = β_{2imag} / β₂ᵣₑₐₗ
      β_{3imag} = β_{3imag} / β₃ᵣₑₐₗ
      β₃₁ᵣₑₐₗ = β₃ᵣₑₐₗ / β₁ᵣₑₐₗ
      FOR j = 0 to 4^{m-t} − 1
        Execute optimized kernel of Listing 4, storing results in Fₜₑₘₚ
      NEXT j
    END IF
  NEXT k
  FOR j = 0 to n−1
    F (j) = Fₜₑₘₚ(j)
  NEXT j
NEXT t
```

In this method, at least one test is performed for each kernel iteration to detect whether an unsafe root exists or not, but in either case the kernel that is executed is optimized to take advantage of FMA instructions. This third example embodiment may be applied to FFTs of at least some other radices as well. A radix-2 kernel implementing the new optimization is shown in Listing 13 below. For mixed-radix implementations, more roots of unity may need to be tested.

Listing 13. Radix-2 Kernel with New Optimization

αᵣₑₐₗ = αᵣₑₐₗ / α_{imag}
r1 = Fᵢₙ(0)ᵣₑₐₗ
s1 = Fᵢₙ(0)_{imag}
r = Fᵢₙ(1)ᵣₑₐₗ
s = Fᵢₙ(1)_{imag}
r2 = r*αᵣₑₐₗ − s
s2 = r + s*αᵣₑₐₗ
Fₒᵤₜ(0)ᵣₑₐₗ = r2*α_{imag} + r1
Fₒᵤₜ(0)_{imag} = s2*α_{imag} + s1
Fₒᵤₜ(1)ᵣₑₐₗ = r1 − r2*α_{imag}
Fₒᵤₜ(1)_{imag} = s1 − s2*α_{imag}

Listing 14 is a pseudo code implementation of a complete radix-2 FFT in accordance with this third example embodiment of the invention. Note that if αᵣₑₐₗ=0.0, it is unnecessary to divide αᵣₑₐₗ by α_{imag}.

Listing 14. Radix-2 FFT in Accordance with a Third Example
Embodiment

```
FOR j = 0 to n−1
  F (j) = x(j)
NEXT j
FOR t = 1 to m
  FOR k= 0 to 2^{t-1} − 1
    α = e^{-2πik/2}^{t}
    IF αᵣₑₐₗ = 0.0 THEN
      FOR j = 0 to 2^{m-t} − 1
        Execute optimized kernel of Listing 13, storing results in Fₜₑₘₚ
      NEXT j
    ELSE
      α_{imag} = α_{imag} / αᵣₑₐₗ
      FOR j = 0 to 2^{m-t} − 1
        Execute optimized kernel of Listing 7, storing results in Fₜₑₘₚ
      NEXT j
    END IF
  NEXT k
  FOR j = 0 to n−1
    F (j) = Fₜₑₘₚ(j)
  NEXT j
NEXT t
```

The optimization used in Listings 11 and 13 enables yet another improvement in performance. When k=0 in an FFT of the form of Listings 12 and 14, e^{-2πik/—}=e⁰=1+0i. Therefore, when k=0, all of the roots of unity used in the FFT kernel are 1+0i. For example, in a radix-4 FFT when k=0, β₁=e^{-2πi*0/4}^{^{t}}=1+0i, β₂=β₁²=(1+0i)²=(1+0i), and β₃=β₁³=(1+0i)³=(1+0i). The computation occurring in the FFT kernel comprises multiplying the real and imaginary parts of the roots of unity by real and imaginary parts of complex data values being operated on by the kernel. When the roots of unity are 1+0i, the multiplications are trivial and can be avoided altogether. Listing 15 below shows a radix-4 kernel that can be used when all of the roots of unity to be used in the kernel are 1+0i.

Listing 15. Radix-4 Kernel for Roots of Unity = 1 + 0i.

r1 = Fᵢₙ(0)ᵣₑₐₗ
s1 = Fᵢₙ(0)_{imag}
r2 = Fᵢₙ(1)ᵣₑₐₗ
s2 = Fᵢₙ(1)_{imag}
r3 = Fᵢₙ(2)ᵣₑₐₗ
s3 = Fᵢₙ(2)_{imag}
r4 = Fᵢₙ(3)ᵣₑₐₗ
s4 = Fᵢₙ(3)_{imag}
r = r1 + r3
s = r2 + r4
Fₒᵤₜ(0)ᵣₑₐₗ = r + s
Fₒᵤₜ(2)ᵣₑₐₗ = r − s
r = r1 − r3
s = s4 − s2
Fₒᵤₜ(1)ᵣₑₐₗ = r − s
Fₒᵤₜ(3)ᵣₑₐₗ = r + s
r = s1 + s3
s = s2 + s4
Fₒᵤₜ(0)_{imag} = r + s
Fₒᵤₜ(2)_{imag} = r − s
r = s1 − s3
s = r4 − r2
Fₒᵤₜ(1)_{imag} = r + s
Fₒᵤₜ(3)_{imag} = r − s

This kernel comprises eight data loading instructions and 16 computational instructions that involve only addition and subtraction. Eight data storing instructions are used as well, for a total of 32 instructions. Listing 16 is a pseudo code implementation of a complete radix-4 FFT in accordance with this fourth example embodiment of the invention.

Listing 16. Radix-4 FFT in Accordance with a Fourth Example
Embodiment

```
FOR j = 0 to n−1
  F (j) = x(j)
NEXT j
FOR t = 1 to m
  FOR j = 0 to 4^{m-t} − 1
    Execute kernel of Listing 15, storing results in Fₜₑₘₚ
  NEXT j
  FOR k = 1 to 4^{t-1} − 1
    β₁ = e^{-2πik/4}^{t}
    β₂ = β₁²
    β₃ = β₁³
    β₁ᵣₑₐₗ = β₁ᵣₑₐₗ / β_{1imag}
    β₂ᵣₑₐₗ = β₂ᵣₑₐₗ / β_{2imag}
    β₃ᵣₑₐₗ = β₃ᵣₑₐₗ / β_{3imag}
    β_{31imag} = β_{3imag} / β_{1imag}
    FOR j = 0 to 4^{m-t} − 1
      Execute optimized kernel of Listing 11, storing results in Fₜₑₘₚ
    NEXT j
  NEXT k
  FOR j = 0 to n−1
    F (j) = Fₜₑₘₚ(j)
  NEXT j
NEXT t
```

The FFT of listing 16 provides a performance improvement, because a significant portion of the kernel executions are performed in the abbreviated kernel. For example, in a radix-4 FFT performed according to Listing 16 with a sequence length n=16384, the abbreviated kernel of Listing 15 is executed 5,461 times, and the optimized kernel of Listing 11 is executed 23,211 times, so that about 19 percent of the kernel executions take advantage of the abbreviated kernel. There is no risk of division by zero, because all roots of unity used in the optimized kernel of Listing 11 have non-zero imaginary parts.

A further advantage of an FFT in accordance with this fourth example embodiment is that the structure of an FFT as implemented in Listings 12 and 14 naturally segregates the kernel iterations that can use the abbreviated kernel from those that use the optimized kernel of Listing 11. There is no need to test any root of unity for a zero real or imaginary part.

This fourth example embodiment may be applied to FFTs of other radices as well. Listing 17 below shows a radix-2 kernel that can be used when all of the roots of unity are 1+0i.

Listing 17. Radix-2 Kernel for Roots of Unity = 1 + 0i.

r1 = Fᵢₙ(0)ᵣₑₐₗ
s1 = Fᵢₙ(0)_{imag}
r2 = Fᵢₙ(1)ᵣₑₐₗ
s2 = Fᵢₙ(1)_{imag}
Fₒᵤₜ(0)ᵣₑₐₗ = r2 + r1
Fₒᵤₜ(0)_{imag} = s2 + s1
Fₒᵤₜ(1)ᵣₑₐₗ = r1 − r2
Fₒᵤₜ(1)_{imag} = s1 − s2

Listing 18 is a pseudo code implementation of a complete radix-2 FFT in accordance with this fourth example embodiment of the invention.

Listing 18. Radix-2 FFT in Accordance with a Fourth Example
Embodiment

```
FOR j = 0 to n−1
  F (j) = x(j)
NEXT j
FOR t = 1 to m
  FOR j = 0 to 2^{m-t} − 1
    Execute kernel of Listing 17, storing results in Fₜₑₘₚ
  NEXT j
  FOR k = 1 to 2^{t-1} − 1
    α₁ = e^{-2πik/2}^{t}
    αᵣₑₐₗ = αᵣₑₐₗ / α_{imag}
    FOR j = 0 to 2^{m-t} − 1
      Execute optimized kernel of Listing 13, storing results in Fₜₑₘₚ
    NEXT j
  NEXT k
  FOR j = 0 to n−1
    F (j) = Fₜₑₘₚ(j)
  NEXT j
NEXT t
```

Other example embodiments of the invention include a computer configured to perform a method embodying the invention, and a computer-readable medium storing instructions for performing a method embodying the invention. A computer may be configured to perform the method, for example, by programming it, or by loading a program into it.

FIG. 3 depicts a block diagram of a computer 300 in accordance with an example embodiment of the invention. Central processing unit (CPU) 301 comprises an arithmetic logic unit that performs computations, including testing of numerical values. CPU 301 may comprise a floating-point computation unit. CPU 301 exchanges data with memory 302. Memory 302 may be random access memory, read-only memory or a combination of these and other kinds of memory. Memory 302 holds both data and program instructions, and program instructions and are sequentially loaded into CPU 301 for execution. Other data and program instructions may reside in storage 303. Storage 303 may be a magnetic or optical disk, magnetic tape, nonvolatile memory, or a combination of these or other kinds of storage. Storage 303 may be fixed or removable. Input/output 304 enables the computer 300 to communicate with a user of computer 300 or with other computers or other devices. Input/output 304 may comprise a keyboard, mouse, display, printer, sound generation device, modem, or a combination of these or other input/output devices or interfaces.

FIG. 4 depicts a pictorial view of computer 300, and a computer-readable medium in accordance with an example embodiment of the invention. Compact disk read-only memory (CD-ROM) 401 is a computer-readable medium storing instructions for performing a method in accordance with an example embodiment of the invention. CD-ROM 401 may be placed into CD-ROM drive 402 on computer 300, and a program loaded fro CD-ROM 401 into memory 302 of computer 300, thereby configuring computer 300 to perform a method in accordance with an example embodiment of the invention.

A computer-readable medium may be, by way of further example, a fixed or removable magnetic disk, a fixed or removable optical disk, or a solid state memory device. A solid state memory device may be, for example, a flash memory, a random-access memory (RAM), a read-only memory (ROM), an erasable programmable read-only memory (EPROM), an electrically erasable programmable read-only memory (EEPROM) or another kind of solid state memory.

1. A method of computing a fast Fourier transform, comprising:
testing a real part of a root of unity;
executing a first kernel when the real part is zero; and
executing a second kernel when the real part is other than zero.

2. The method of claim 1, further comprising:
dividing an imaginary part of the root of unity by the real part of the root of unity before executing the second kernel; and
performing computation in the second kernel using fused multiply-add computer instructions.

3. A method of computing a fast Fourier transform, comprising:
testing an imaginary part of a root of unity;
executing a first kernel when the imaginary part is zero; and
executing a second kernel when the imaginary part is other than zero.

4. The method of claim 3, further comprising:
dividing a real part of the root of unity by the imaginary part of the root of unity before executing the second kernel; and
performing computation in the second kernel using fused multiply-add computer instructions.

5. A computer, comprising a central processing unit and configured to perform the following method:
testing a real part of a root of unity;
executing a first fast Fourier transform kernel when the real part is zero; and
executing a second fast Fourier transform kernel when the real part is other than zero.

6. The computer of claim 5, wherein the method further comprises:
dividing an imaginary part of the root of unity by the real part of the root of unity before executing the second kernel; and
performing computation in the second kernel using fused multiply-add computer instructions.

7. A computer, comprising a central processing unit and configured to perform the following method:
testing an imaginary part of a root of unity;
executing a first fast Fourier transform kernel when the imaginary part is zero; and
executing a second fast Fourier transform kernel when the imaginary part is other than zero.

8. The computer of claim 7, wherein the method further comprises:
dividing a real part of the root of unity by the imaginary part of the root of unity before executing the second kernel; and
performing computation in the second kernel using fused multiply-add computer instructions.

9. A computer-readable medium storing instructions for performing the following method:
testing a real part of a root of unity;
executing a first fast Fourier transform kernel when the real part is zero; and
executing a second fast Fourier transform kernel when the real part is other than zero.

10. The computer-readable medium of claim 5, wherein the method further comprises:
dividing an imaginary part of the root of unity by the real part of the root of unity before executing the second kernel; and
performing computation in the second kernel using fused multiply-add computer instructions.

11. A computer-readable medium storing instructions for performing the following method:
testing an imaginary part of a root of unity;
executing a first fast Fourier transform kernel when the imaginary part is zero; and
executing a second fast Fourier transform kernel when the imaginary part is other than zero.

12. The computer-readable medium of claim 11, wherein the method further comprises:
dividing a real part of the root of unity by the imaginary part of the root of unity before executing the second kernel; and
performing computation in the second kernel using fused multiply-add computer instructions.

13. A computer, comprising:
means for testing one of two parts of a complex root of unity;
means for executing a first fast Fourier transform kernel when the tested part is zero; and
means for executing a second fast Fourier transform kernel when the tested part is other than zero.

14. A method of computing a fast Fourier transform, comprising:
testing a real part of a root of unity;
replacing the real part with a safe finite value when the real part is zero;
dividing an imaginary part of the root of unity by the real part; and
performing computations in a kernel using fused multiply-add computer instructions.

15. The method of claim 14, performed in a system with a minimum safe finite value, and wherein the safe finite value replacing the real part is the minimum safe finite value.

16. A method of computing a fast Fourier transform, comprising:
testing an imaginary part of a root of unity;
replacing the imaginary part with a safe finite value when the imaginary part is zero;
dividing a real part of the root of unity by the imaginary part; and
performing computations in a kernel using fused multiply-add computer instructions.

17. The method of claim 16, performed in a system with a minimum safe finite value, and wherein the safe finite value replacing the imaginary part is the minimum safe finite value.

18. A computer, comprising a central processing unit and configured to perform the following method:
testing a real part of a root of unity;
replacing the real part with a safe finite value when the real part is zero;
dividing an imaginary part of the root of unity by the real part; and
performing computations in a fast Fourier transform kernel using fused multiply-add computer instructions.

19. The computer of claim 18, wherein a minimum safe finite value exists for the computer, and wherein the safe finite value replacing the real part is the minimum safe finite value.

20. A computer, comprising a central processing unit and configured to perform the following method:
testing an imaginary part of a root of unity;
replacing the imaginary part with a safe finite value when the imaginary part is zero;
dividing a real part of the root of unity by the imaginary part; and
performing computations in a fast Fourier transform kernel using fused multiply-add computer instructions.

21. The computer of claim 20, wherein a minimum safe finite value exists for the computer, and wherein the safe finite value replacing the imaginary part is the minimum safe finite value.

22. A computer-readable medium storing instructions for performing the following method:
testing a real part of a root of unity;
replacing the real part with a safe finite value when the real part is zero;
dividing an imaginary part of the root of unity by the real part; and
performing computations in a fast Fourier transform kernel using fused multiply-add computer instructions.

23. The computer-readable medium of claim 22, wherein a minimum safe finite value exists for the computer, and wherein the safe finite value replacing the real part is the minimum safe finite value.

24. A computer-readable medium storing instructions for performing the following method:
testing an imaginary part of a root of unity;
replacing the imaginary part with a safe finite value when the imaginary part is zero;
dividing a real part of the root of unity by the imaginary part; and
performing computations in a fast Fourier transform kernel using fused multiply-add computer instructions.

25. The computer-readable medium of claim 24, wherein a minimum safe finite value exists for the computer, and wherein the safe finite value replacing the imaginary part is the minimum safe finite value.

26. A computer, comprising:
means for testing a first of two parts of a complex root of unity;
means for replacing the part with a safe finite value when the part is zero;
means for dividing a second of the two parts by the first part; and
means for performing computations in a fast Fourier transform kernel using fused multiply-add computer instructions.

27. A method of computing a fast Fourier transform, comprising:
testing a root of unity having real and imaginary parts; and
when the imaginary part of the root of unity is zero, executing a first kernel that performs its computations using fused multiply-add computer instructions;
when the real part of the root of unity is zero, executing a second kernel that performs its computations using fused multiply-add computer instructions.

28. The method of claim 27, further comprising when the real part of the root of unity is zero, dividing a real part of a second root of unity by an imaginary part of the second root of unity before executing the second kernel.

29. The method of claim 27, further comprising when the imaginary part of the root of unity is zero, dividing an imaginary part of a second root of unity by a real part of the second root of unity before executing the first kernel.

30. The method of claim 27, further comprising when the neither part of the root of unity is zero, executing either of the two kernels.

31. A computer, comprising a central processing unit and configured to perform the following method:
testing a root of unity having real and imaginary parts; and
when the imaginary part of the root of unity is zero, executing a first kernel that performs its computations using fused multiply-add computer instructions;
when the real part of the root of unity is zero, executing a second kernel that performs its computations using fused multiply-add computer instructions.

32. The computer of claim 31, wherein, when the real part of the root of unity is zero, the method further comprises dividing a real part of a second root of unity by an imaginary part of the second root of unity before executing the second kernel.

33. The computer of claim 31, wherein, when the imaginary part of the root of unity is zero, the method further comprises dividing an imaginary part of a second root of unity by a real part of the second root of unity before executing the first kernel.

34. The computer of claim 31, wherein, when neither part of the root of unity is zero, the method further comprises executing either of the two kernels.

35. A computer-readable medium storing instructions for performing the following method:
testing a root of unity having real and imaginary parts; and
when the imaginary part of the root of unity is zero, executing a first kernel that performs its computations using fused multiply-add computer instructions;
when the real part of the root of unity is zero, executing a second kernel that performs its computations using fused multiply-add computer instructions.

36. The computer-readable medium of claim 35, wherein, when the real part of the root of unity is zero, the method further comprises dividing a real part of a second root of unity by an imaginary part of the second root of unity before executing the second kernel.

37. The computer-readable medium of claim 35, wherein, when the imaginary part of the root of unity is zero, the method further comprises dividing an imaginary part of a second root of unity by a real part of the second root of unity before executing the first kernel.

38. The computer-readable medium of claim 35, wherein, when neither part of the root of unity is zero, the method further comprises executing either of the two kernels.

39. A computer, comprising:
means for testing a first of two parts of a complex root of unity;
means for, when the first part of the root of unity is zero, executing a first kernel fast Fourier transform that performs its computations using fused multiply-add computer instructions; and
means for, when the second part of the root of unity is zero, executing a second fast Fourier transform kernel that performs its computations using fused multiply-add computer instructions.

40. A method of computing a fast Fourier transform, comprising:
for a set of kernel iterations in which all roots of unity used in the kernel are known to have zero imaginary parts, executing a first kernel without multiply instructions; and
for a second set of kernel iterations in which all roots of unity used in the kernel are known to have nonzero imaginary parts, dividing a real part of a root of unity used in the kernel by its corresponding imaginary part, and executing a second kernel that performs its computations using fused multiply-add instructions.

41. A computer, comprising a central processing unit and configured to perform the following method:
for a set of kernel iterations in which all roots of unity used in the kernel are known to have zero imaginary parts, executing a first kernel without multiply instructions; and
for a second set of kernel iterations in which all roots of unity used in the kernel are known to have nonzero imaginary parts, dividing a real part of a root of unity used in the kernel by its corresponding imaginary part, and executing a second kernel that performs its computations using fused multiply-add instructions.

42. A computer-readable medium storing instructions for performing the following method:
for a set of kernel iterations in which all roots of unity used in the kernel are known to have zero imaginary parts, executing a first kernel without multiply instructions; and
for a second set of kernel iterations in which all roots of unity used in the kernel are known to have nonzero imaginary parts, dividing a real part of a root of unity used in the kernel by its corresponding imaginary part, and executing a second kernel that performs its computations using fused multiply-add instructions.

43. A computer, comprising:
means for executing a first fast Fourier transform kernel, the first kernel used for a set of kernel iterations in which all roots of unity used in the kernel are known to have zero imaginary parts;
means for executing a second fast Fourier transform kernel, the second kernel used for a second set of kernel iterations in which all roots of unity used in the kernel are known to have nonzero imaginary parts and performing its computations using fused multiply-add computer instructions; and
means for dividing a real part of a root of unity used in the second kernel by its corresponding imaginary part.
